(19) United States
(12) Patent Application Publication
(10) Pub. No.: US 2022/0099435 A1
(43) Pub. Date: Mar. 31, 2022

(54) THREE-DIMENSIONAL (3D) SPACE SCANNER WITH OIS FUNCTION

(71) Applicant: Samsung Electro-Mechanics Co., Ltd., Suwon-si (KR)

(72) Inventors: Yun Hee LEE, Suwon-si (KR); Hae Seung HYUN, Suwon-si (KR); Hyun KIM, Suwon-si (KR); Kyoung Tai LEE, Suwon-si (KR)

(73) Assignee: Samsung Electro-Mechanics Co., Ltd., Suwon-si (KR)

(21) Appl. No.: 17/349,981

(22) Filed: Jun. 17, 2021

(30) Foreign Application Priority Data
Sep. 29, 2020 (KR) 10-2020-0127217

(51) Int. Cl. G01B 11/25; G01S 17/89; G01S 17/86; G01S 17/42; G01S 7/481

(52) U.S. Cl. CPC G01B 11/2518; G01S 17/89; G01S 7/4817; G01S 17/42; G01S 17/86

(57) ABSTRACT

A three-dimensional space scanner including a light transmitter and a light receiver, to perform two-dimensional scanning is provided. The three-dimensional scanner includes a hand-shake sensor configured to detect hand-shake sensing information corresponding to hand-shake, during a scanning operation using the light transmitter; and a control circuit configured to control hand-shake compensation for the three-dimensional space scanner based on the hand-shake sensing information.

### CROSS-REFERENCE TO RELATED APPLICATION(S)

This application claims the benefit under 35 USC § 119(a) of Korean Patent Application No. 10-2020-0127217 filed on Sep. 29, 2020 in the Korean Intellectual Property Office, the entire disclosure of which is incorporated herein by reference for all purposes.

### BACKGROUND

### 1. Field

The following description relates to a three-dimensional (3D) space scanner with an optical image stabilizer (OIS) function.

### 2. Description of Related Art

Typically, in order to provide various user experiences by analyzing and reconstructing a three-dimensional (3D) space using a camera, the development of three-dimensional sensing modules for smartphones is increasing.

As a three-dimensional space analysis method using a camera, time-of-flight (ToF) technology, which estimates distance from a moving time of a signal, is widely used.

Three-dimensional sensing modules are also being applied to mobile devices, to support various functions.

Currently, a measurable distance of a ToF three-dimensional sensing module may be limited to 3 to 5 m due to various reasons such as being hazardous for the human body or the like. Interest in how the measurable distance of a three-dimensional sensing module may be increased without increasing an output, is increasing. Additionally, it may be beneficial to implement technology that transmits light for a relatively long distance without being lost.

Additionally, typical three-dimensional (3D) space scanners include technology that controls an output device to form an output pattern of a light source such as a diffractive optical element (DOE) or the like, to reach the light source further with the same output, in order to focus the light source of the same output on only a portion of an angle of view.

However, in typical three-dimensional (3D) space scanners, as a pattern of the light source is formed, output power to be allocated for each pattern increases, and a distance to be reached increases, but there may be a disadvantage in that depth information captured by an infrared sensor may be limited to the DOE pattern, not to obtain depth information for the entire region of the infrared sensor at an angle of view.

In this case, in order to obtain depth information of a region that cannot be captured by the infrared sensor, a technology that increases density of a pattern by mounting an actuator to a light source to three-dimensionally scan the light source at several points has been proposed.

However, in typical three-dimensional (3D) space scanners using the actuator, in a case of a small device held by a user's hand, there may be a problem that hand-shake of the user may occur, and the hand-shake may affect a scanning process to deteriorate sensing results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a three-dimensional (3D) space scanner, including a light transmitter and a light receiver to perform two-dimensional scanning, the 3D space scanner includes a hand-shake sensor, configured to detect hand-shake sensing information corresponding to hand-shake, during a scanning operation with the light transmitter; and a control circuit, configured to control hand-shake compensation for the 3D space scanner based on the detected hand-shake sensing information.

The control circuit may include a first driver circuit, configured to compensate for a first scan driving signal based on a first target position with respect to the light transmitter, based on the detected hand-shake sensing information, to generate a first driving signal; and a scan signal processor, configured to process a scan signal input by the light receiver.

The control circuit may include a first driver circuit, configured to output a first scan driving signal based on a first target position with respect to the light transmitter, as a first driving signal; a second driver circuit, configured to generate a second driving signal for hand-shake compensation based on the detected hand-shake sensing information with respect to the light receiver; and a scan signal processor, configured to process a scan signal input by the light receiver.

The control circuit may include a first driver circuit, configured to compensate for a first scan driving signal based on a first target position with respect to the light transmitter, based on the detected hand-shake sensing information, to generate a first driving signal; a second driver circuit, configured to generate a second driving signal for hand-shake compensation based on the detected hand-shake sensing information with respect to the light receiver; and a scan signal processor, configured to process a scan signal input by the light receiver.

The 3D space scanner may further include a first actuator on which the light transmitter is mounted, wherein the actuator is configured to operate based on the first driving signal generated by the first driver circuit.

The 3D space scanner may further include a first actuator, on which the transmitter is mounted, and the first actuator configured to operate based on the first driving signal generated by the first driver circuit; and a second actuator, on which the light receiver is mounted, and the second actuator is configured to operate based on the second driving signal generated by the second driver circuit.

The first driver circuit may include a first scan driver, configured to generate the first scan driving signal based on the first target position with respect to the light transmitter; and a first compensator, configured to compensate for the first scan driving signal based on the detected hand-shake sensing information, to generate the first driving signal.

The second driver circuit may include a second compensator, configured to generate the second driving signal for hand-shake compensation based on the detected hand-shake sensing information.

In a general aspect, a three-dimensional (3D) space scanner includes a light transmitter, configured to generate transmission light to perform a two-dimensional scanning operation; a light receiver, configured to receive light incident on a subject from the light transmitter; a hand-shake sensor, configured to detect hand-shake sensing information corresponding to hand-shake, during a scanning operation with the light transmitter; a control circuit, configured to control the two-dimensional scanning operation using the light transmitter and the light receiver, and configured to control hand-shake compensation for the three-dimensional space scanner based on the hand-shake sensing information; and an actuator, configured to operate based on a control signal from the control circuit.

The control circuit may include a first driver circuit, configured to compensate for a first scan driving signal based on a first target position with respect to the light transmitter, based on the hand-shake sensing information, to generate a first driving signal; and a scan signal processor, configured to process a scan signal input by the light receiver.

The control circuit may include a first driver circuit, configured to output a first scan driving signal based on a first target position with respect to the light transmitter, as a first driving signal; a second driver circuit, configured to generate a second driving signal for hand-shake compensation based on the hand-shake sensing information with respect to the light receiver; and a scan signal processor, configured to process a scan signal input by the light receiver.

The control circuit may include a first driver circuit, configured to compensate for a first scan driving signal based on a first target position with respect to the light transmitter, based on the hand-shake sensing information, to generate a first driving signal; a second driver circuit, configured to generate a second driving signal for hand-shake compensation based on the hand-shake sensing information with respect to the light receiver; and a scan signal processor, configured to process a scan signal input by the light receiver.

The 3D scanner may further include a first actuator, configured to mount the light transmitter, and configured to operate based on the first driving signal generated by the first driver circuit.

The 3D scanner may further include a first actuator, configured to mount the light transmitter, and configured to operate based on the first driving signal generated by the first driver circuit; and a second actuator, configured to mount the light receiver, and configured to operate based on the second driving signal generated by the second driver circuit.

The 3D scanner may further include a first scan driver, configured to generate the first scan driving signal based on the first target position with respect to the light transmitter; and a first compensator, configured to compensate for the first scan driving signal using the hand-shake sensing information, to generate the first driving signal.

The second driver circuit may include a second compensator, configured to generate the second driving signal for hand-shake compensation based on the hand-shake sensing information.

Other features and aspects will be apparent from the following detailed description, the drawings, and the claims.

### BRIEF DESCRIPTION OF DRAWINGS

FIG. 1 is a view illustrating an example three-dimensional space scanner, in accordance with one or more embodiments.

FIG. 2 is a view illustrating an example three-dimensional space scanner, in accordance with one or more embodiments.

FIG. 3 is a configuration view illustrating the control circuit of FIG. 1.

FIG. 4 is a configuration view illustrating the control circuit of FIG. 1.

FIG. 5 is a configuration view illustrating the control circuit of FIG. 1.

FIG. 6 is a configuration view illustrating a first OIS driver circuit.

FIG. 7 is a configuration view illustrating a second OIS driver circuit.

FIGS. 8A to 8C illustrate example irradiation patterns of a light source.

FIGS. 9A and 9B illustrate examples of the occurrence of hand-shake.

FIGS. 10A and 10B illustrate examples of the occurrence of hand-shake.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application, and are not to be interpreted in an idealized or overly formal sense unless expressly so defined herein.

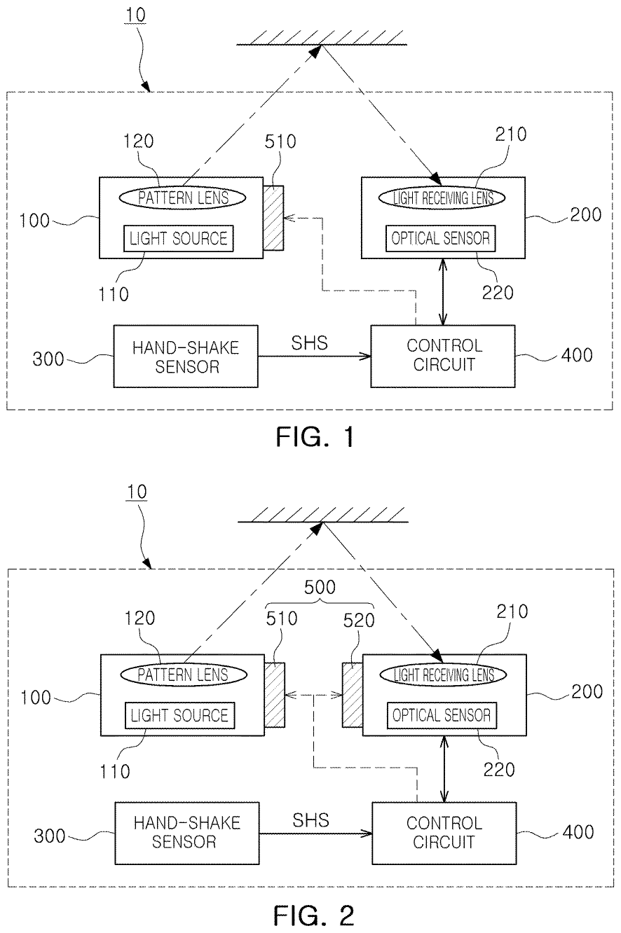

FIG. 1 is a view illustrating an example three-dimensional space scanner, in accordance with one or more embodiments, and FIG. 2 is a view illustrating an example three-dimensional space scanner, in accordance with one or more embodiments.

Referring to FIGS. 1 and 2, a three-dimensional space scanner 10, in accordance with one or more embodiments may include a light transmitter 100, a light receiver 200, a hand-shake sensor 300, and a control circuit 400. Additionally, the three-dimensional space scanner 10 may include an actuator 500.

The light transmitter 100 may generate transmission light to implement two-dimensional (2D) scanning, and may irradiate the transmission light toward a subject.

In an example, the light transmitter 100 may include a light source 110 and a pattern lens 120. The light source 110 may generate transmission light. The pattern lens 120 may be manufactured to generate a specific pattern of light, to form the specific pattern in the transmission light generated by the light source 110.

In an example, the transmission light generated by the light source 110 may be infrared pulsed light, and the light transmitter 100 may be configured with a vertical cavity surface emitting laser (VCSEL) formed of a laser diode, but is not limited thereto.

In an example, when the light transmitter 100 includes a VCSEL, the generated transmission light may be irradiated in a vertical direction.

In an example, an irradiation pattern may be a specific type of pattern such as a dot pattern. However, the examples are not limited thereto.

In an example, the pattern lens 120 may be a diffractive optical element (DOE) lens, but is not limited thereto.

In an example, the DOE lens may generate a specific pattern on a surface of the lens to induce diffraction of light, such that a specific pattern is included in the irradiated light. Therefore, the specific pattern of the light may be irradiated on a surface of the subject. In an example, the light source may generally use a wavelength in the infrared region, but is not limited thereto.

In an example, when the DOE lens is applied as a pattern lens to the light source unit 100, light may be irradiated to a narrower region with the same output power, to obtain an effect of increasing a measureable distance.

In an example where the irradiation pattern is a dot pattern, when a three-dimensional space to which the dot pattern is irradiated is three-dimensionally scanned, a density of the pattern may be increased by filling an empty space of a dot using an interpolation method or the like.

The light receiver 200 may receive light incident on the subject after the light is transmitted from the light transmitter 100.

In an example, the light receiver 200 may include a light receiving lens 210 and an optical sensor 220. The light receiving lens 210 may be implemented to collect light such that the light reflected from the subject forms an image on a surface of the optical sensor 220. The optical sensor 220 may sense the light incident through the light receiving lens 210, and may provide a sensing signal to the control circuit 400.

Thereafter, the control circuit 400 may perform predetermined signal processing on an optical signal input from the light receiver 200, to calculate depth information of a three-dimensional space.

The hand-shake sensor 300 may detect hand-shake sensing information SHS corresponding to hand-shake. In an example, the hand-shake sensor 300 may include, as a non-limiting example, a gyro sensor. The gyro sensor may output angular velocity information corresponding to hand-shake information.

The control circuit 400 may control a two-dimensional scan using the light transmitter 100 and the light receiver 200, and may control hand-shake compensation for the three-dimensional space scanner, based on the hand-shake sensing information SHS.

Referring to FIG. 1, the actuator 500 may include a first actuator 510 on which the light transmitter 100 is mounted.

Referring to FIG. 2, the actuator 500 may include a first actuator 510 on which the light transmitter 100 is mounted, and a second actuator 520 on which the light receiver 200 is mounted.

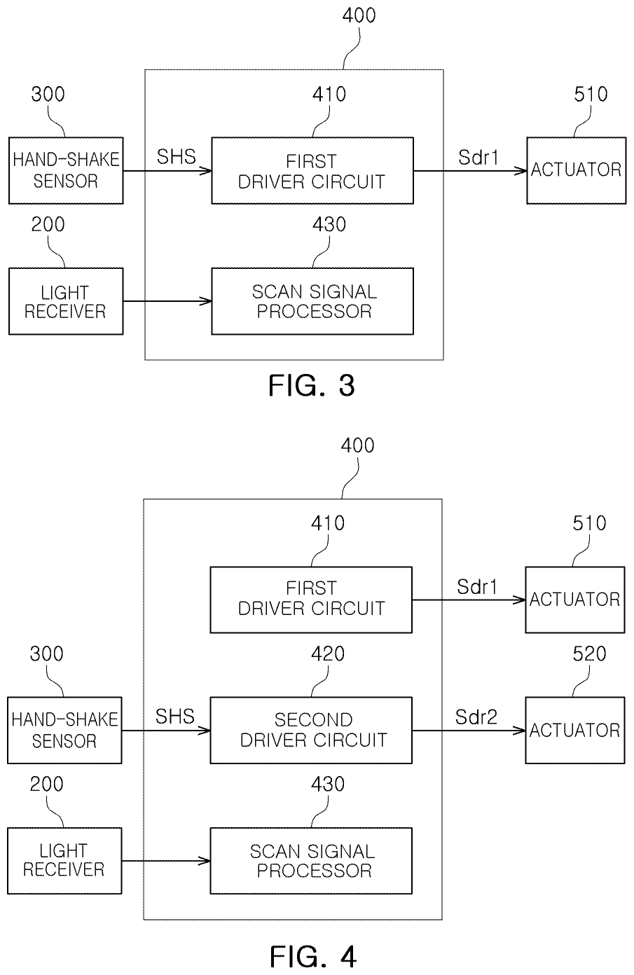

Referring to FIGS. 1 and 2, the first actuator 510 may have the light transmitter 100 mounted thereon, and may operate according to a first driving signal Sdr1 received from a first driver circuit 410 (FIGS. 3 to 5).

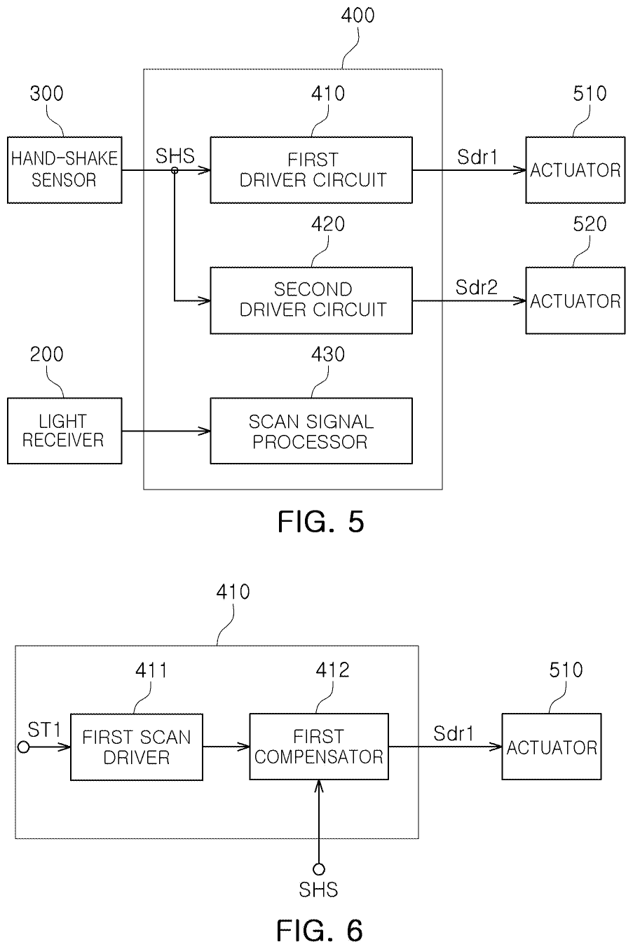

Referring to FIG. 2, the second actuator 520 may have the light receiver 200 mounted thereon, and may operate according to the second driving signal Sdr2 received from a second driver circuit 420 (FIGS. 4 and 5).

Each of the first actuator 510 and second actuator 520, described above, may be driven according to the respective first and second driving signals Sdr1 and Sdr2 for which hand-shake is compensated, to compensate for hand-shake, and thus, may be OSI actuators.

For each of the drawings of the present disclosure, unnecessarily duplicated descriptions may be omitted for the same reference numerals and components having the same functions, and possible differences for each of the drawings may be described.

FIG. 3 is a configuration view illustrating the control circuit of FIG. 1.

Referring to FIG. 3, the control circuit 400 may include a first driver circuit 410 and a scan signal processor 430.

The first driver circuit 410 may compensate for a first scan driving signal Sd1 based on a first target position with respect to the light transmitter 100, based on the hand-shake sensing information SHS, to generate a first driving signal Sdr1.

Additionally, the scan signal processing unit 430 may process a scan signal input by the light receiver 200.

Therefore, the first actuator 510 may perform movement and hand-shake compensation for a scan operation, based on the first driving signal Sdr1.

FIG. 4 is a configuration view illustrating the control circuit of FIG. 1.

Referring to FIG. 4, the control circuit 400 may include a first driver circuit 410, a second driver circuit 420, and a scan signal processor 430.

The first driver circuit 410 may output a first scan driving signal Sd1 based on a first target position with respect to the light transmitter 100, as a first driving signal Sdr1.

The second driver circuit 420 may generate a second driving signal Sdr2 for hand-shake compensation based on the hand-shake sensing information SHS with respect to the light receiver 200.

Additionally, the scan signal processor 430 may process a scan signal input by the light receiver 200.

Therefore, the first actuator 510 may perform movement for a scan operation according to the first driving signal Sdr1, and the second actuator 520 may perform hand-shake compensation.

FIG. 5 is a configuration view illustrating the control circuit of FIG. 1.

Referring to FIG. 5, the control circuit 400 may include a first driver circuit 410, a second driver circuit 420, and a scan signal processor 430.

The first driver circuit 410 may compensate for a first scan driving signal Sd1 based on a first target position with respect to the light transmitter 100, based on the hand-shake sensing information SHS, to generate a first driving signal Sdr1.

The second driver circuit 420 may generate a second driving signal Sdr2 for hand-shake compensation based on the hand-shake sensing information SHS with respect to the light receiver 200.

Additionally, the scan signal processor 430 may process a scan signal input by the light receiver 200.

Therefore, the first actuator 510 may perform movement and hand-shake compensation for a scan operation, based on the first driving signal Sdr1, and the second actuator 520 may perform hand-shake compensation.

FIG. 6 is a configuration view illustrating a first OIS driver circuit.

Referring to FIG. 6, a first driver circuit 410 may include a first scan driver 411 and a first compensator 412.

The first scan driver 411 may generate a first scan driving signal Sd1 based on a first target position ST1 with respect to a light transmitter 100.

The first compensator 412 may compensate for the first scan driving signal Sd1 using a hand-shake sensing information SHS, to generate a first driving signal Sdr1.

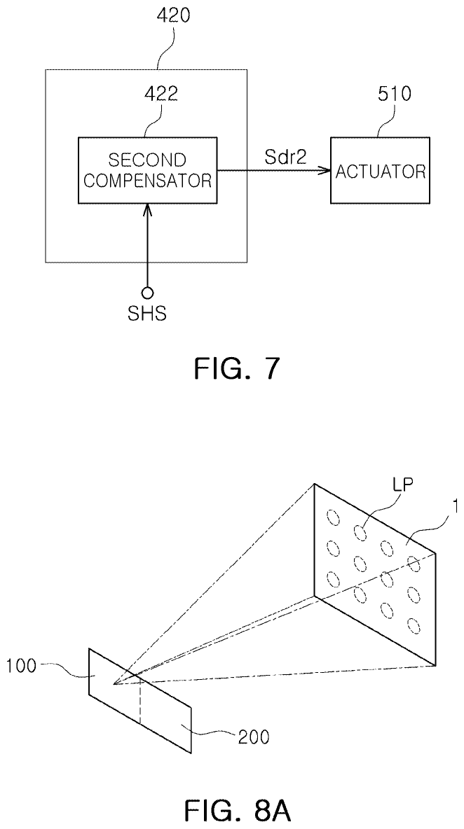

FIG. 7 is a configuration view illustrating a second OIS driver circuit.

Referring to FIG. 7, a second driver circuit 420 may include a second compensator 422.

The second compensator 422 may generate a second driving signal Sdr2 for hand-shake compensation based on hand-shake sensing information SHS.

Additionally, an OIS operation of the examples may operate simultaneously with light source scanning. In an example, when hand-shake is detected by a hand-shake sensor 300 during scanning of a light source, and there is driving control for hand-shake compensation by at least one of first and second driver circuits 410 and 420, at least one of the respective first and second actuators 510 and 520 having an OIS function may reflect a movement amount for hand-shake to add or subtract a scanning movement of the light source.

When distortion is expected in a designed scanning pattern due to an effect of hand-shake by the above-described operation, compensation may be performed such that a pattern of the light source finally irradiated to a subject becomes the same as those designed.

The light receiver 200 may or may not be moved for a scanning operation. Although an example in which the light receiver 200 is not moved is described in this example, the present disclosure is not limited thereto.

Additionally, an OIS hand-shake compensation method may also be performed as several methods, such as a lens shift method in which a lens moves, a module tilt method in which modules including a sensor entirely move, and the like, and there is no need to be limited to any one thereof.

In an example, in the lens shift method, a sensor may be fixed and a lens unit may move horizontally in an opposite direction by an amount of hand-shake detected by a hand-shake sensor unit, to remove an effect of the hand-shake.

As another example, in the module tilt method, a transmitter or a receiver may move rotationally in an opposite direction, in a manner in which they entirely move, by an amount of hand-shake detected by a hand-shake sensor, to remove an effect of the hand-shake.

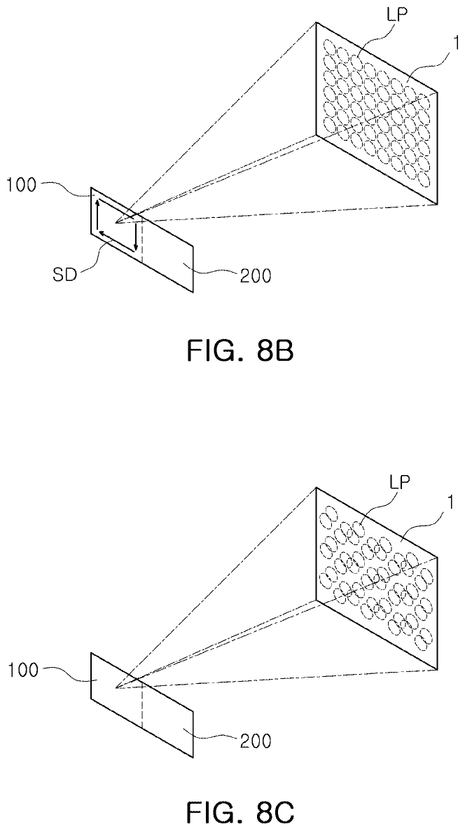

FIGS. 8A-8C illustrate example irradiation patterns of a light source.

FIG. 8A illustrates a light source irradiation pattern for an example in which a scanning pattern does not move. FIG. 8B illustrates an increase in density of a light source irradiation pattern for an example in which a scanning pattern moves. FIG. 8C illustrates a light source irradiation pattern for an example in which hand-shake occurs while a scanning pattern moves.

Referring to FIG. 8A and 8B, it can be seen that when the example in which a scanning pattern moves, a density of a light source irradiation pattern is further increased, as compared to the example in which a scanning pattern does not move.

In an example, referring to FIG. 8B, a scanning direction SD may move in a predetermined direction, such as a counterclockwise direction, and may move to have various shapes such as, but not limited to, a square, a triangle, and a straight line, depending on particular examples. A light source may be irradiated to a wider area of a subject by scanning according to the scanning direction.

Referring to portions FIG. 8B and 8C, in the example in which hand-shake occurs while a scanning pattern moves, it can be seen that a light source pattern is not irradiated to an original predetermined position due to the effect of the hand-shake, to reduce three-dimensional sensing performance. Therefore, it can be seen that an appropriate compensation operation is required for hand-shake.

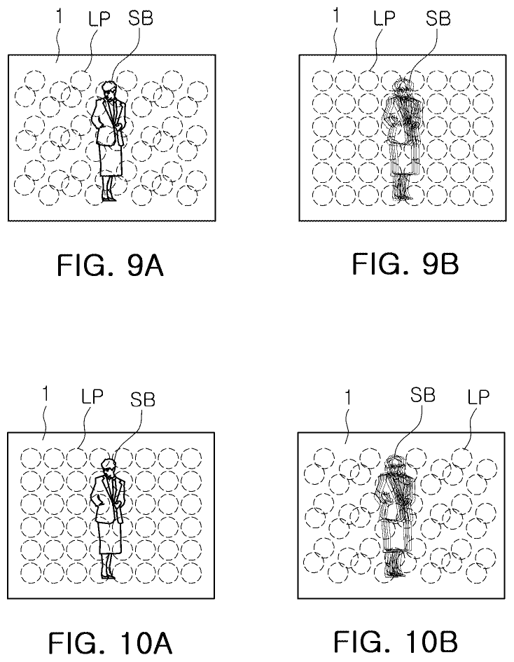

FIGS. 9A and 9B illustrate examples of the occurrence of hand-shake.

FIG. 9A illustrates an irradiation pattern, when hand-shake occurs, for an example in which an OIS function is not applied to a light transmitter, the OIS function is applied to a light receiver, and a scanning pattern moves. FIG. 9B illustrates an irradiation pattern, when hand-shake occurs, for an example in which an OIS function is applied to a light transmitter, the OIS function is not applied to a light receiver, and a scanning pattern moves.

Referring to FIG. 9A and 9B, when hand-shake occurs, it can be seen that appropriate hand-shake compensation may be necessary because the light transmitter and the light receiver may be respectively affected by the hand-shake.

FIGS. 10A and 10B illustrate examples of the occurrence of hand-shake.

FIG. 10A illustrates an irradiation pattern, when hand-shake occurs, for an example in which an OIS function is applied to a light transmitter and a light receiver, and a scanning pattern moves. FIG. 10B illustrates an irradiation pattern, when hand-shake occurs, for an example in which an OIS function is not applied to a light transmitter and a light receiver, and a scanning pattern moves.

Referring to FIGS. 9A, 9B, 10A, and 10B, when the example in which an OIS function is applied to a light transmitter and a light receiver, compares to the example in which the OIS function is not applied to the light transmitter and the light receiver, it can be seen that, in the example in which the OIS function is not applied to the light transmitter and the light receiver, a light source pattern (LP) and a subject (SB) may not be shaken. Therefore, it can be seen that a usage of the OIS function is effective.

A three-dimensional (3D) space scanner of the present disclosure may be mounted on a digital device such as, but not limited to, a smartphone or the like, to sense three-dimensional space information. In an example, the three-dimensional (3D) space scanner may be mounted around a general camera such as, but not limited to, a smartphone, a tablet computer, an AR/VR device, or the like, and may operate in conjunction with the camera.

A control circuit of a three-dimensional space scanner according to an example may be implemented in computing environments (e.g., a peripheral component interconnection (PCI), a USB, firmware (IEEE 1394), an optical bus structure, a network, and the like) in which a processor (e.g., a central processing unit (CPU), a graphics processing unit (GPU), a microprocessor, an application specific integrated circuit (ASIC), a field programmable gate array (FPGA), and the like), a memory (e.g., a volatile memory (e.g., an RAM and the like), a non-volatile memory (e.g., an ROM, a flash memory, and the like), an input device (e.g., a keyboard, a mouse, a pen, a voice input device, a touch input device, an infrared camera, a video input device, and the like), an output devices (e.g., a display, a speaker, a printer, and the like), and a communication access device (e.g., a modem, a network interface card (NIC), an integrated network interface, a radio frequency transmitter/receiver, an infrared port, a USB connection device, and the like) are interconnected to each other.

The computing environments may be implemented in a distributed computing environment including a personal computer, a server computer, a handheld or laptop device, a mobile device (e.g., a mobile phone, a PDA, a media player, and the like), a multiprocessor system, a consumer electronic, a mini-computer, a mainframe computer, or any of the aforementioned systems or devices, but is not limited thereto.

According to an example, as a three-dimensional space scanner has an OIS function that compensates for hand-shake, there may be an advantage that the three-dimensional space scanner may compensate for hand-shake that may occur during a scanning operation, to remove an effect of the hand-shake during the scanning operation, and may perform more precise scanning work.

Additionally, as it is applied to a three-dimensional (3D) space scanner using a pattern light source, there may be an advantage in that it may scan a longer distance in three-dimensional space without being affected by the user's hand-shake by using an output of the pattern light source.

While this disclosure includes specific examples, it will be apparent after an understanding of the disclosure of this application that various changes in forms and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A three-dimensional (3D) space scanner, comprising a light transmitter and a light receiver that perform two-dimensional scanning, the 3D space scanner comprising:
a hand-shake sensor, configured to detect hand-shake sensing information corresponding to hand-shake, during a scanning operation with the light transmitter; and
a control circuit, configured to control hand-shake compensation for the 3D space scanner based on the detected hand-shake sensing information.

2. The 3D space scanner of claim 1, wherein the control circuit comprises:
a first driver circuit, configured to compensate for a first scan driving signal based on a first target position with respect to the light transmitter, based on the detected hand-shake sensing information, to generate a first driving signal; and
a scan signal processor, configured to process a scan signal input by the light receiver.

3. The 3D space scanner of claim 1, wherein the control circuit comprises:
a first driver circuit, configured to output a first scan driving signal based on a first target position with respect to the light transmitter, as a first driving signal;
a second driver circuit, configured to generate a second driving signal for hand-shake compensation based on the detected hand-shake sensing information with respect to the light receiver; and
a scan signal processor, configured to process a scan signal input by the light receiver.

4. The 3D space scanner of claim 1, wherein the control circuit comprises:
a first driver circuit, configured to compensate for a first scan driving signal based on a first target position with respect to the light transmitter, based on the detected hand-shake sensing information, to generate a first driving signal;
a second driver circuit, configured to generate a second driving signal for hand-shake compensation based on the detected hand-shake sensing information with respect to the light receiver; and
a scan signal processor, configured to process a scan signal input by the light receiver.

5. The 3D space scanner of claim 4, further comprising a first actuator on which the light transmitter is mounted,
wherein the actuator is configured to operate based on the first driving signal generated by the first driver circuit.

6. The 3D space scanner of claim 4, further comprising:
a first actuator, on which the transmitter is mounted, and the first actuator configured to operate based on the first driving signal generated by the first driver circuit; and
a second actuator, on which the light receiver is mounted, and the second actuator is configured to operate based on the second driving signal generated by the second driver circuit.

7. The 3D space scanner of claim 4, wherein the first driver circuit comprises:
a first scan driver, configured to generate the first scan driving signal based on the first target position with respect to the light transmitter; and
a first compensator, configured to compensate for the first scan driving signal based on the detected hand-shake sensing information, to generate the first driving signal.

8. The 3D space scanner of claim 4, wherein the second driver circuit comprises a second compensator, configured to generate the second driving signal for hand-shake compensation based on the detected hand-shake sensing information.

9. A three-dimensional (3D) space scanner, comprising:
a light transmitter, configured to generate transmission light to perform a two-dimensional scanning operation;
a light receiver, configured to receive light incident on a subject from the light transmitter;
a hand-shake sensor, configured to detect hand-shake sensing information corresponding to hand-shake, during a scanning operation with the light transmitter;
a control circuit, configured to control the two-dimensional scanning operation using the light transmitter and the light receiver, and configured to control hand-shake compensation for the three-dimensional space scanner based on the detected hand-shake sensing information; and
an actuator, configured to operate based on a control signal from the control circuit.

10. The 3D space scanner of claim 9, wherein the control circuit comprises:
a first driver circuit, configured to compensate for a first scan driving signal based on a first target position with respect to the light transmitter, based on the detected hand-shake sensing information, to generate a first driving signal; and
a scan signal processor, configured to process a scan signal input by the light receiver.

11. The 3D space scanner of claim 9, wherein the control circuit comprises:
a first driver circuit, configured to output a first scan driving signal based on a first target position with respect to the light transmitter, as a first driving signal;
a second driver circuit, configured to generate a second driving signal for hand-shake compensation based on the detected hand-shake sensing information with respect to the light receiver; and
a scan signal processor, configured to process a scan signal input by the light receiver.

12. The 3D space scanner of claim 9, wherein the control circuit comprises:
a first driver circuit, configured to compensate for a first scan driving signal based on a first target position with respect to the light transmitter, based on the detected hand-shake sensing information, to generate a first driving signal;
a second driver circuit, configured to generate a second driving signal for hand-shake compensation based on the detected hand-shake sensing information with respect to the light receiver; and
a scan signal processor, configured to process a scan signal input by the light receiver.

13. The 3D space scanner of claim 12, further comprising a first actuator, configured to mount the light transmitter, and configured to operate based on the first driving signal generated by the first driver circuit.

14. The 3D space scanner of claim 12, further comprising:
a first actuator, configured to mount the light transmitter, and configured to operate based on the first driving signal generated by the first driver circuit; and
a second actuator, configured to mount the light receiver, and configured to operate based on the second driving signal generated by the second driver circuit.

15. The 3D space scanner of claim 12, wherein the first driver circuit comprises:
a first scan driver, configured to generate the first scan driving signal based on the first target position with respect to the light transmitter; and
a first compensator, configured to compensate for the first scan driving signal using the hand-shake sensing information, to generate the first driving signal.

16. The 3D space scanner of claim 12, wherein the second driver circuit comprises a second compensator, configured to generate the second driving signal for hand-shake compensation based on the hand-shake sensing information.
